(19) United States
(12) Patent Application Publication
(10) Pub. No.: US 2008/0166029 A1
(43) Pub. Date: Jul. 10, 2008

(54) Method And Apparatus For Biometric Analysis Of Sweat Ducts

(75) Inventor: Cristian Presura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,297

(22) PCT Filed: Feb. 9, 2006
(86) PCT No.: PCT/IB2006/050423

§ 371 Date: Aug. 15, 2007

(30) Foreign Application Priority Data
Feb. 18, 2005 (EP) 05101227.6

(51) Int. Cl. G06K 9/00

(52) U.S. Cl. 382/124

(57) ABSTRACT

Sweat ducts present on finger prints can be used in biometric identification or authentication systems as a differentiating or corroborating biometric feature. In addition, the activity of sweat ducts can be seen as a proof of liveness. By stimulating an object such as a finger by blowing air over the skin surface, it is possible to evoke sweat from the sweat ducts. The presence of these small droplets of sweat on the skin surface can be used to locate the position of sweat ducts, using either a spatial or temporal analysis of images of the skin surface. In addition, a temporal analysis can highlight sweat duct activity, which in turn can be used as a proof of liveness.

The invention relates to an apparatus for biometric analysis of sweat ducts on a part of the skin surface of an object.

The invention further relates to a method of biometric analysis of sweat ducts on a part of the skin surface of an object.

The human skin plays an important role in controlling body temperature. Perspiration is one of the most effective methods for lowering body temperature. Perspiration or sweat is produced by the sudoriferous glands more commonly known as sweat glands. Most sweat glands are eccrine sweat glands, which are found almost all over the skin surface of the human body but are most numerous on the palms of human hands and soles of human feet. On the skin surface, the sweat ducts are visible as pores.

Sweat originating from the sweat glands travels through the sweat ducts towards the pores on the skin surface. Here, sweat can evaporate and help cool the body in hot environments. Sweat can also be triggered by nerve fibers that encircle the sweat glands in response to excitement, anxiety or fear.

The use of perspiration for spoof detection in biometric analysis is described in international application WO 01/24700 entitled “Spoof detection for biometric sensing systems”.

A particular apparatus described in this publication makes use of the fact that a living finger perspires. An increase in temperature results in an increase in surface moisture due to perspiration. This increased surface moisture can be measured and used as a sign of liveness to corroborate additional identification or authentication.

The aforementioned apparatus requires an increase in temperature to evoke sweat. This can complicate other measurements that require a fixed environmental temperature, such as finger temperature measurement.

It is an object of the invention to provide an alternative method and apparatus for biometric analysis of sweat ducts on a part of the skin surface of an object that does not use an increase in temperature to evoke sweat from said sweat ducts.

This object is realized in that the apparatus for biometric analysis of the type set forth in the introductory paragraph further comprises:

a skin stimulation means for blowing air over said skin surface to evoke sweat from said sweat ducts,

a skin image capture means arranged to sample said skin surface of an object and create an electrical skin surface representation.

The human skin contains between 1.6 and 4 million sweat glands, most of which are eccrine sweat glands. Sweat produced in the eccrine sweat glands travels to the skin surface via the sweat ducts. The position of a sweat duct does not disappear, move or change spontaneously over time. Sweat duct positions are considered unique and can be used as a differentiating biometric characteristic for identification or authentication.

When the human skin, and a finger tip in particular, is exposed to air under normal environmental conditions (e.g. an environmental temperature of 23° C. and a relative humidity of 45%) and the person under examination is at ease, then there is limited or no sweat on the skin surface.

However, when under these conditions the skin is stimulated by blowing air on the skin using an air blower, sweat is evoked from the sweat ducts and becomes apparent by small sweat droplets forming near and around pores. Experiments have shown that the temperature of the air blown on the skin surface is not critical.

The formation of droplets of sweat can be observed and measured. Not only can the position of these droplets help in locating the sweat ducts, which in turn can be used for identification or authentication purposes, but an additional temporal analysis can provide information about the activity of the actual sweat ducts before and after stimulation. The activity of sweat ducts can be considered to be a sign of liveness of the object (e.g. finger) being analyzed.

The effectiveness of sweat evocation by means of air stimulation depends on the object (e.g. finger) temperature. The sweat response increases with a higher object temperature. Experiments have shown that even sweat ducts on cold fingers can produce a sweat response following stimulation with air, although the number of responsive pores decreases with temperature.

Other factors that affect the effectiveness of the air stimulation are medical conditions that cause excessive sweating or lack of sweating. Examples of such medical conditions are: hyperhidrosis and hypohidrosis, also known as anhidrosis.

The method according to the invention is realized in that the biometric analysis method of the type set forth in the introductory paragraph further comprises steps wherein:

said skin surface is stimulated by blowing air over it, to evoke sweat from said sweat ducts,

said skin surface is sampled, thus creating an electrical skin surface representation of said skin surface.

These and other aspects of the biometric identification apparatus will be further elucidated and described with reference to the drawings, in which:

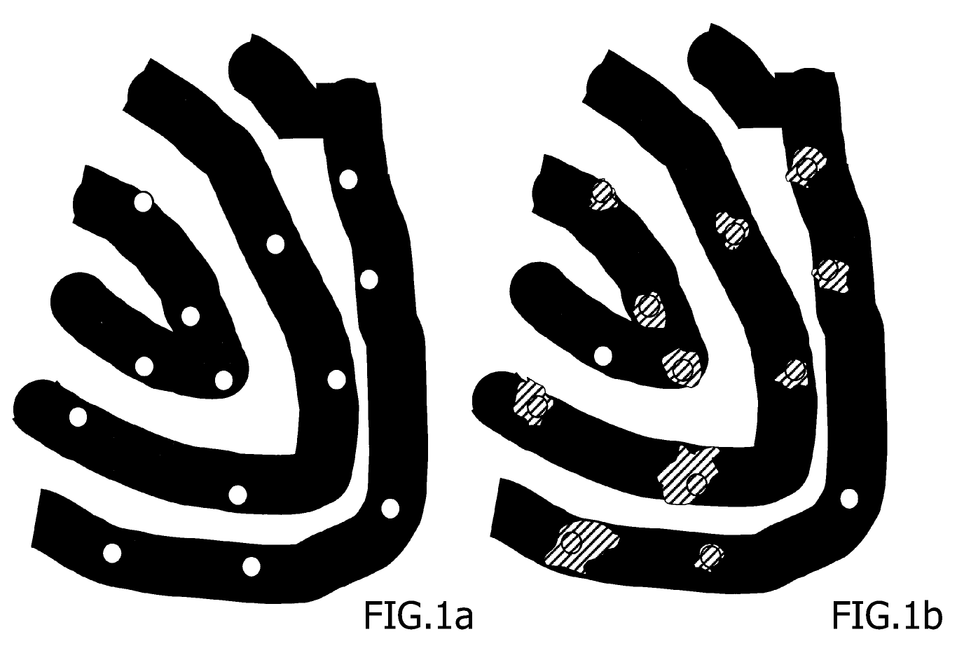

FIG. 1 comprises two representations of a partial fingerprint before (a) and after (b) use of an air blower on the finger tip;

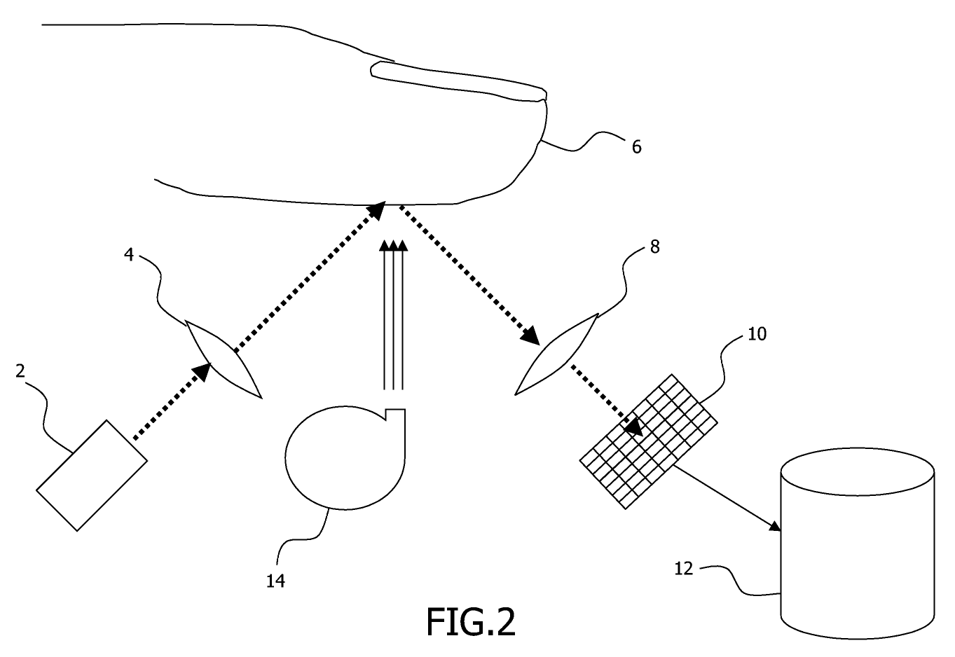

FIG. 2 is a schematic representation of the skin image capture means and air blower for use in an apparatus according to the invention;

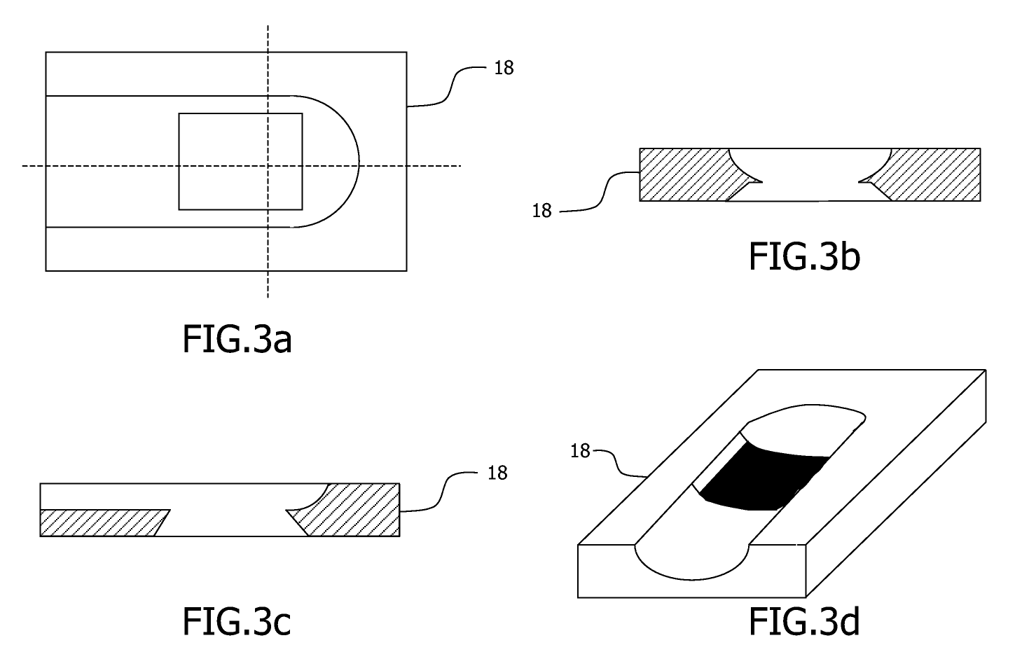

FIG. 3 is a series of graphic representations of a cradle, showing a top view (a), two cross-sections (b) and (c) as well as an impression (d) of a cradle for use in certain embodiments of the invention;

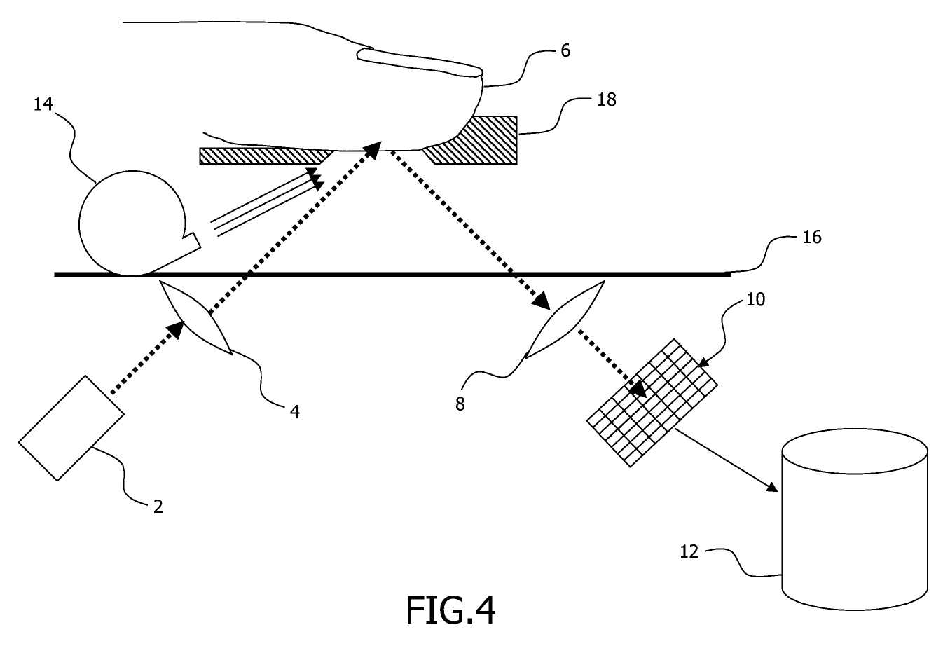

FIG. 4 is a more detailed schematic representation of a skin image capture means and air blower for use in an apparatus according to the invention;

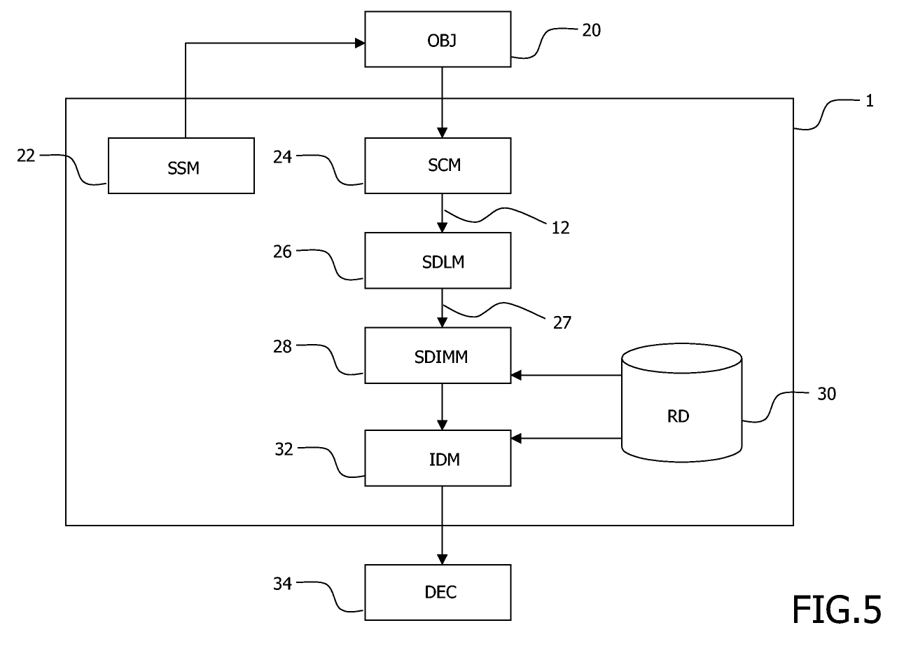

FIG. 5 is a block diagram of an apparatus for biometric analysis of sweat ducts according to the invention, arranged for identification;

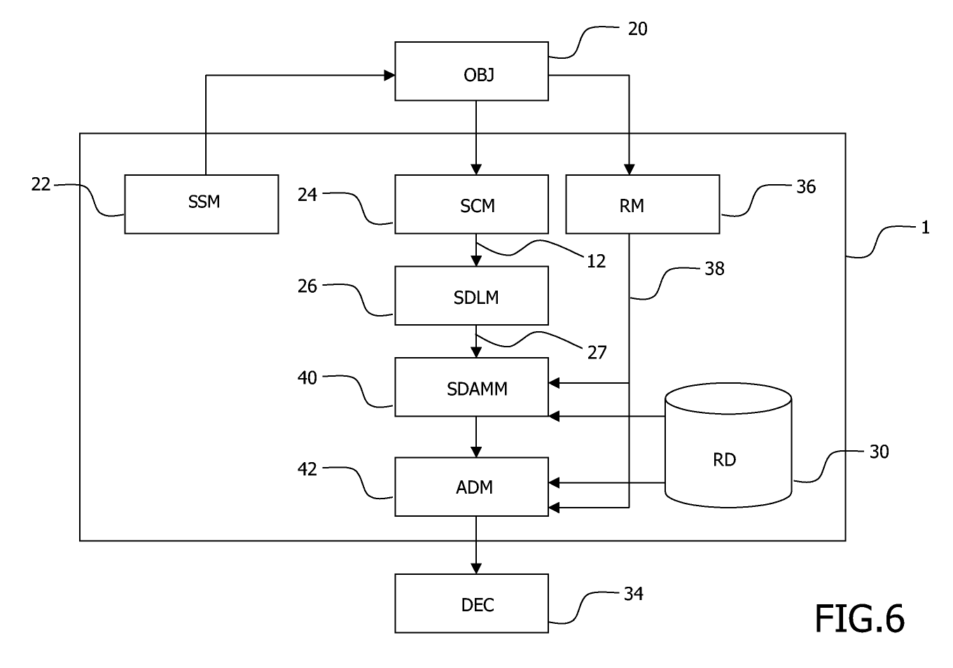

FIG. 6 is a block diagram of an apparatus for biometric analysis of sweat ducts according to the invention, arranged for authentication;

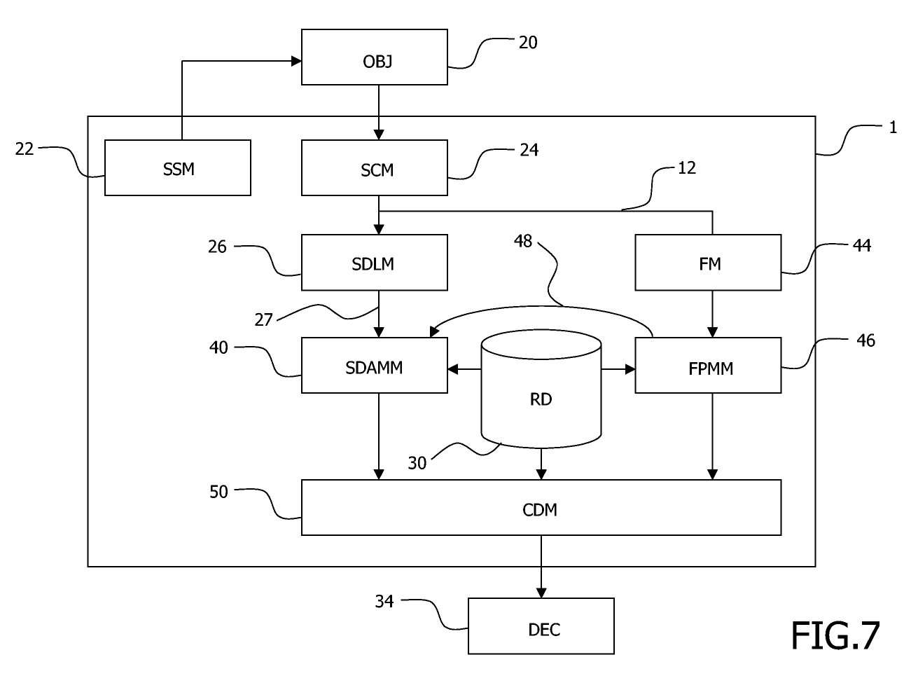

FIG. 7 is a block diagram of an apparatus for biometric analysis of sweat ducts according to the invention that uses sweat duct position information and fingerprint information for identification;

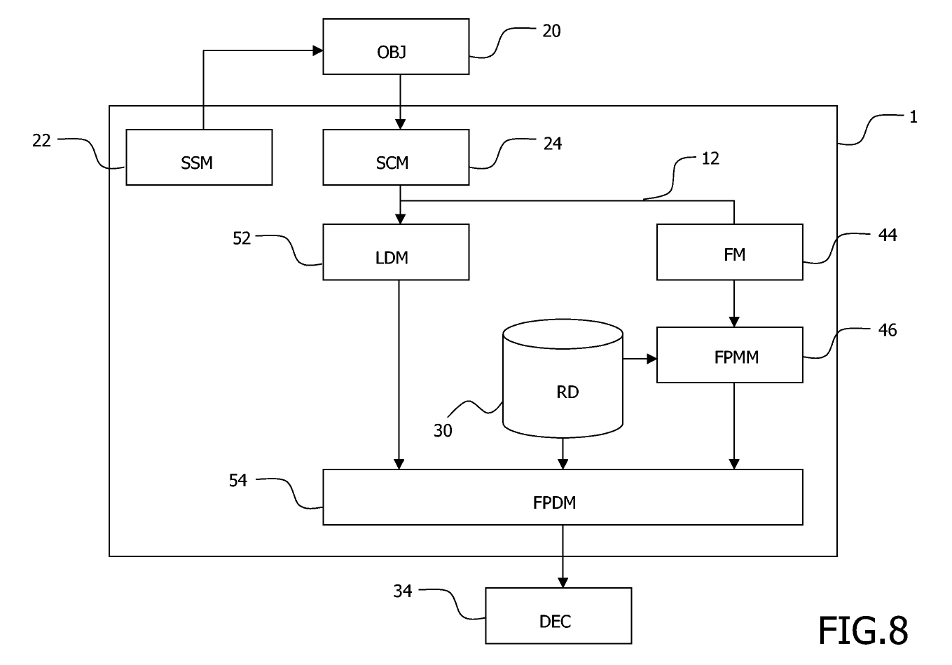

FIG. 8 is a block diagram of an apparatus for biometric analysis of sweat ducts according to the invention that uses sweat duct information as a proof of liveness and fingerprint information for identification.

Throughout the drawings, the same reference numerals refer to the same elements, or to elements that perform the same function.

The invention is based on the principle that blowing air over part of the skin surface of an object evokes sweat from the sweat ducts on this skin surface. This principle is illustrated in FIG. 1. FIG. 1 depicts two representations of a partial fingerprint before (FIG. 1a) and after (FIG. 1b) stimulation with an air blower. Both representations are based on actual images.

The representation in FIG. 1a shows the ridges of a partial fingerprint in black, and pores on the ridges as white circles. The representation in FIG. 1b shows the same partial fingerprint one second after stimulation of a part of the skin surface, using an air blower. Ridges are shown in black. White (filled) circles represent pores that are not covered with sweat. The hatched areas that cover the bulk of the pore locations are droplets of sweat. The droplets typically cover the actual pores and a small adjacent area.

On the actual images, the droplets are easily recognized due to their smooth surface and high reflectivity compared to that of the skin surface. As a result, the droplets generally show very bright and dark spots. These spots result from relatively large amounts of light being reflected directly in the camera (bright spot) or outside the view of the camera (dark spot). These spots give the sweat droplets very distinctive and thereby easily recognizable features.

It is evident from FIGS. 1a and 1b that it is possible to perform a temporal analysis and calculate the deltas between the two images in FIGS. 1a and 1b. The contrast provided by the ridges can be used to compensate for an offset in the pictures. Subsequently, a difference signal can be calculated that contains information about the position of the droplets of sweat.

Alternatively, a single electrical skin surface representation after stimulation could be used to locate the position of sweat ducts by locating the aforementioned droplets of sweat. Although the location of these droplets does not fully determine the position of the sweat ducts, the droplets are generally over, or adjacent to the position of sweat ducts. As the droplets are easier to locate than pores, the invention can also simplify sweat duct location without temporal analysis.

Embodiments of the invention comprise a skin image capture means to create an electrical skin surface representation of an object. FIG. 2 is a schematic representation of a skin image capture means combined with an air blower. A light source 2 is used to irradiate a finger 6. Optionally, a lens 4 is used to focus the light from the light source 2 onto the skin surface of the finger 6. Light scatters from the finger 6 and part of the scattered light is focused by a lens 8 onto a detector array 10. The detector array 10 creates an electrical skin surface representation 12 of the finger 6. The air blower 14 is used to provide the skin surface stimulation characteristic for embodiments of the invention.

The skin image capture means depicted in FIG. 2 has the drawback that the finger 6 under analysis can move freely. In practice, this will result in problems related to focusing, and tracking of the finger 6 under analysis. An elegant way of avoiding these problems is the use of a cradle.

FIG. 3 depicts such a cradle 18. FIG. 3a is a top view, FIGS. 3b and 3c depict two cross-sections, and FIG. 3d shows an impression of a cradle for use in certain embodiments of the invention. The cradle 18 allows positioning of the finger 6 under analysis, locking it in position but allowing light and air to reach a part of the skin surface of the finger 6 through an opening in the bottom of the cradle.

FIG. 4 is a more detailed schematic representation of a skin image capture means and air blower for use in an apparatus according to the invention. It comprises a cradle 18 for positioning the finger 6 under analysis, as well as a transparent plate 16 to protect the optics of the device. The air blower 14 is positioned above the transparent plate 16, below the cradle 18, allowing air from the blower to brush a part of the skin surface of the finger 6 under analysis.

Biometric identification and authentication apparatus form an important class of biometric analysis means. Biometric identification and authentication are closely related.

In biometric identification, an object is identified as having a certain identity when measured biometric features match within a predefined tolerance with pre-recorded biometric features stored in a reference database. Effectively, one object is matched with many entries in the reference database.

Biometric authentication differs from identification in that an alleged identity is provided of the object being authenticated (e.g. using a badge reader). Subsequently, the measured biometric features of the object presented for authentication are matched with the pre-recorded biometric features in the database associated with the alleged identity, provided that the identity is in the reference database. Effectively, one object is matched with one entry in the reference database.

The actual matching process used for identification and authentication may differ. During identification, one particular entry has to be selected, requiring differentiation and matching, whereas during authentication only matching is required. This implies that identification requires uniqueness and compliance of features, whereas authentication only requires compliance of features.

FIGS. 5 and 6 further show details of the structure of an apparatus for biometric analysis of sweat ducts on a part of the skin surface of an object for identification and authentication, respectively.

FIG. 5 is a block diagram of a biometric analysis apparatus 1 for identification in situ. It depicts a biometric analysis apparatus 1 that analyses an object 20, and produces a decision 34.

The apparatus comprises a skin simulation means 22 for evoking sweat from the sweat ducts on a part of the skin surface of the object 20. The apparatus further comprises a skin image capture means 24 arranged to create an electrical skin surface representation 12 of the object 20. This electrical representation is passed on to a sweat duct location means 26 that locates the position of sweat ducts on a part of the skin surface based on one or more electrical representations.

The sweat duct location means 26 generates and passes an electrical sweat duct position representation 27 to a sweat duct identification matching means 28. The sweat duct identification matching means 28 matches the sweat duct position data with pre-recorded sweat duct patterns in a reference database 30. Finally an identification decision means 32 decides whether a sufficient match is found within a pre-defined tolerance.

The decision 34 of the identification decision means 32 may be a bi-exact or hard-decision, such as is needed for automated access control. Alternatively, it may be a soft decision, including a measure of probability of correctness. The latter could be particularly useful in expert systems for assisting security personnel.

FIG. 6 is a block diagram of a biometric analysis apparatus 1 for authentication in situ. As its general structure resembles that of the apparatus for identification as shown in FIG. 5, only its distinctive features will be described here. The apparatus depicted in FIG. 6 comprises a requesting means 36 to request an alleged identity 38 from the object 20. In practical systems, the requesting means 36 may be implemented as a badge reader, or a machine passport reader.

Similarly to the situation in FIG. 5, a sweat duct location means 26 generates an electrical sweat duct position representation 27. This information and the alleged identity are important inputs to a sweat duct authentication matching means 40. The sweat duct authentication matching means 40 matches the sweat duct position data with a pre-recorded sweat duct pattern in the reference database for the alleged identity, provided that it is present in the reference database. Finally, an authentication decision means 42 decides whether a sufficient match is found within a pre-defined tolerance. This decision is not restricted to a hard decision.

Apart from embodiments that use sweat duct information as the differentiating biometric feature for identification or authentication, sweat duct information can also be used in conjunction with other biometric identification and authentication techniques.

One of the key reasons for combining biometric identification apparatus is increased reliability. This increase in reliability does not have to be at the expense of a severe increase in workload. In fact, when there are two identification techniques wherein one is more demanding than the other, it is possible to first perform identification based on the least demanding technique to obtain a small set of likely candidates, and subsequently use this set as “search area” for the second, more demanding technique.

FIG. 7 illustrates an apparatus for biometric analysis of sweat ducts on a part of the skin surface of an object that is enhanced with techniques for fingerprint identification. The combination of sweat duct and fingerprint identification techniques is particularly interesting because both techniques observe different aspects of the same surface, and hence can share the same skin image capture means.

In FIG. 7, a skin image capture means 24 captures an electrical skin surface representation 12. As a rule, the resolution required for locating sweat duct positions in such a representation is higher than that needed for recording ridges in fingerprints. By capturing an electrical skin surface representation at a resolution suitable for sweat duct detection, and down sampling it for the fingerprint analysis on the fly, a single pass capture can suffice. Although the areas that are used for the sweat duct analysis and the fingerprint analysis may overlap, they do not need to be identical.

Down sampling is handled by a filter means 44. The output of the filter means 44 is passed on to a fingerprint matching means for identification 46. The fingerprint matching means matches the ridge patterns with pre-recorded ridge patterns in a reference database 30. When a match is found within a pre-defined tolerance with an entry in the reference database 30, an interim identity 48 is said to be established.

The interim identity 48, and other related information can be passed on to a sweat duct authentication matching means 40. In parallel, a sweat duct location means 26 generates an electrical sweat duct position representation 27. Together with the alleged identity, this electrical representation is an important input for a sweat duct authentication matching means 40. This will match the sweat duct positions with the biometric sweat duct pattern stored in the reference database for the interim identity.

Finally, a combined decision means 50 evaluates information from both the sweat duct authentication matching means 40 as well as the fingerprint matching means 46, with data from the reference database 30 to a decision 34.

Combining different techniques may be useful for frustrating spoof attacks. Simple spoof attacks such as the use of “gummy” fingers in fingerprint identification can be thwarted by the addition of a liveness test. The invention can be used to locate sweat ducts and observe activity in the form of sweat evocation for use as a proof of liveness.

FIG. 8 illustrates an apparatus 1 for biometric analysis of sweat ducts on a part of the skin surface of an object that uses sweat duct information as a proof of liveness and fingerprint information for identification. The block diagram in FIG. 8 resembles that of FIG. 7. Only the differences will be described here.

Based on one or more electrical skin surface representations 12 captured by a skin image capture means 24, a liveness detection means 52 determines whether or not the object 20 offered for analysis has active sweat ducts. Together with information from a fingerprint matching means 46, this information and information from a reference database 30 is combined to a decision 34 by a fingerprint identification decision means 54. In this case, the fingerprint identification decision means 54 uses the results from the liveness detection means 52 to corroborate the outcome of the fingerprint matching means 46.

The invention has been described with reference to particular embodiments. It should, however, be noted that the protective scope of the invention is not limited to these embodiments.

1-16. (canceled)

17. An apparatus (1) for matching of sweat ducts on a part of the skin surface of a finger, the apparatus comprising:
a skin stimulation means (22) for blowing air over said skin surface to evoke sweat from said sweat ducts,
a skin image capture means (24) arranged to sample said skin surface and create an electrical skin surface representation (12), the skin image capture means comprising a sweat duct location means (26) arranged to locate positions of sweat ducts on said skin surface using the electrical skin surface representation (12) and create an electrical sweat duct position representation (27) of the sweat duct positions, and
a sweat duct matching means (28) arranged to match information comprising the electrical sweat duct position representation (27) with a pre-recorded sweat duct pattern in a reference database (30).

18. An apparatus (1) as claimed in claim 17, further comprising an identification decision means (32) arranged to use information from the sweat duct matching means (28) to generate a decision (34) identifying a match, within a predefined tolerance, with an entry in the reference database (30).

19. An apparatus (1) as claimed in claim 17, further comprising a requesting means (36) arranged to obtain an alleged identity (38) associated with the finger, and wherein the sweat duct matching means (40) is arranged to match information comprising the electrical sweat duct position representation (27) with a pre-recorded sweat duct pattern in a reference database (30) corresponding to the alleged identity (38).

20. An apparatus (1) as claimed in claim 19, further comprising an authentication decision means (42) arranged to use information from the sweat duct matching means (40) to generate a decision (34) identifying a match, within a predefined tolerance, with an entry in the reference database (30) associated with the alleged identity (38).

21. An apparatus (1) as claimed in claim 17, further comprising a liveness detection means (52) arranged to use information from the skin image capture means (24) to observe changes in electrical representations of said skin surface over time.

22. An apparatus (1) as claimed in claim 21, further comprising a biometric identification means (54) using information from the liveness detection means (52) to corroborate the biometric identification or authorization.

23. An apparatus (1) as claimed in claim 21, further comprising a biometric authorization means (54) using information from the liveness detection means (52) to corroborate the biometric identification or authorization.

24. An apparatus (1) as claimed in claim 17, further comprising a cradle (18) for positioning a finger.

25. A method of matching sweat ducts on a part of the skin surface of a finger, comprising
stimulating said skin surface by blowing air over it, to evoke sweat from said sweat ducts,
sampling said skin surface, thus creating an electrical skin surface representation (12) of said skin surface,
locating positions of sweat ducts on said skin surface using the electrical skin surface representation (12) and
creating an electrical sweat duct representation (27) of the sweat duct positions, and
matching information comprising the electrical sweat duct representation (27) with a pre-recorded sweat duct pattern in a reference database (30).

26. A method as claimed in claim 25, wherein changes in the electrical skin surface representation (12) over time are used to determine liveness.

27. A method as claimed in claim 25, wherein a proof of liveness in the form of changes in the electrical skin surface representation (12) over time are used to corroborate one of biometric identification and biometric authentication.
